(19) United States
(12) Patent Application Publication
(10) Pub. No.: US 2023/0267633 A1
(43) Pub. Date: Aug. 24, 2023

(54) METHOD FOR OPERATING AN ASSISTANCE SYSTEM FOR DETERMINING A LENGTH OF AN OBJECT, COMPUTER PROGRAM PRODUCT, COMPUTER-READABLE STORAGE MEDIUM AND ASSISTANCE SYSTEM

(71) Applicant: Valeo Schalter und Sensoren GmbH, Bietigheim-Bissingen (DE)

(72) Inventors: Muhammad Nassef Abdelkader Hassaan, Bietigheim-Bissingen (DE); Jean Francois Bariant, Bietigheim-Bissingen (DE)

(73) Assignee: Valeo Schalter und Sensoren GmbH, Bietigheim-Bissingen (DE)

(21) Appl. No.: 18/020,368

(22) PCT Filed: Aug. 2, 2021
(86) PCT No.: PCT/EP2021/071517

§ 371 Date: Feb. 8, 2023

(30) Foreign Application Priority Data
Aug. 11, 2020 (DE) 10 2020 121 061.2

(51) Int. Cl. G06T 7/60; G06V 20/58; G06V 10/764; G06V 10/84

(52) U.S. Cl. CPC G06T 7/60; G06V 20/58; G06V 10/764; G06V 10/84; G06T 2207/30261; G06V 2201/08

(57) ABSTRACT

The invention relates to a method for operating an assistance system (2), in which an object (9) is detected and the object (9) is classified for further evaluation by means of an electronic computing device (5), wherein the classification is taken as a basis for predefining a first length (L) of the object (9), and wherein additionally the object (9) is captured by means of a camera (4), evaluated and classified and a second length (L) of the object (9) is determined and the classification and the second length (L) are transmitted to the electronic computing device (5), wherein the predefined first length (L) is adapted on the basis of the second length (L) to produce a current length (L) and a limited Kalman filter (7) is used to update the current length (L), the limitation of the Kalman filter (7) being predefined by the classification determined by means of the camera (4). The invention also relates to a computer program product, a computer-readable storage medium and an assistance system (2).

The invention relates to a method for operating an assistance system of a motor vehicle, in which an object in the surroundings of the motor vehicle is detected by means of a detection device of the assistance system and the object is classified by means of an electronic computing device of the assistance system for further evaluation by means of the electronic computing device, wherein a first length of the object is specified for the further evaluation by means of the electronic computing device as a function of the classification, and wherein in addition the object is detected and evaluated by means of a camera of the assistance system and is classified by means of the camera and a second length of the object is determined and the classification and the second length are transferred to the electronic computing device for further evaluation. Furthermore, the invention relates to a computer program product, a computer-readable storage medium, and an assistance system.

It is known that cameras in motor vehicles, for example a front camera in the motor vehicle, cannot measure a length of a dynamic object The camera classifies the object and a specified length for this object is then determined in dependence on this classification. In particular, the classification of the camera is not very stable, for example, since it changes the class multiple times, for example, from a passenger vehicle to a truck. If an update of an item of object information, for example in the case of object tracking, should then be carried out by the specified length from the camera, a change of the length, for example, on the basis of another sensor, thus cannot be carried out. For example, it can be specified by the camera that an object is 2.5 m long, while a lidar sensor device gives an item of information, for example, that the object is 5 m long. This results in conflicts in a tracking algorithm, so that the corresponding length can only be determined and used with difficulty.

US 2013/0245929 A1 discloses a filter method for sensor data, which are formed by a sensor system for detecting objects. A scaling value is measured from the sensor data, wherein the scaling value corresponds to a change of the size of an object from the sensor data over a time interval, and a measurement error parameter of the scaling value is determined and Kalman filtering is executed, which is based directly on the measured scaling value, the time interval, and the measurement error parameter, in order to estimate at least one normed movement parameter of the object relative to the sensor system.

CN105631414 A relates to a vehicle-borne device and method for classifying multiple obstacles on the basis of a Bayesian classifier. The classifying device consists of a camera and a PC, which is connected to the camera, a Kalman filter module for carrying out the Kalman filtering on the video image of the vehicle front recorded by a camera and for recognizing an obstacle, a feature extraction module, which is used to carry out the feature extraction on the recognized obstacle, and a Bayesian classification module, which is used for the use of a Bayesian classifier, in order to obtain the classification of the obstacle target according to the features of the obstacle target, wherein the features comprise a symmetry feature, a feature of the horizontal edge linearity, and a feature of the length and width ratio, and the classification comprises a bicyclist/motorcyclist, a vehicle lateral surface, a vehicle front side, and pedestrians.

The object of the present invention is to provide a method, a computer program product, a computer-readable storage medium, and an assistance system, by means of which improved object tracking can be carried out for a motor vehicle.

This object is achieved by a method, a computer program product, a computer-readable storage medium, and an assistance system according to the independent claims. Advantageous embodiments are specified in the dependent claims.

One aspect of the invention relates to a method for operating an assistance system of a motor vehicle, in which an object in the surroundings of the motor vehicle is detected by means of a detection device of the assistance system and the object is classified by means of an electronic computing device of the assistance system for further evaluation by means of the electronic computing device, wherein a first length of the object is specified in dependence on the classification for the further evaluation by means of the electronic computing device and wherein in addition the object is detected and evaluated by means of a camera of the assistance system and is classified by means of the camera and a second length of the object is determined and the classification and the second length are transferred to the electronic computing device for further evaluation.

It is provided that the specified first length is adapted in dependence on the second length determined by means of the camera to form a current length by means of the electronic computing device and the current length is updated by means of a constrained Kalman filter of the electronic computing device, wherein the constraint of the Kalman filter is predetermined by the classification determined by means of the camera.

It is thus made possible that improved object tracking, which can also be referred to as object tracking, can be carried out In particular, for example, current items of length information about the object can thus be adapted. In particular, the invention thus solves the problem that the length determined by means of the camera can be updated by means of other sensors, without conflicts arising between further items of information about the length with the other sensors.

In other words, a method for processing the data of a vehicle camera, in particular a front camera, is proposed, or for tracking objects in the vehicle surroundings by means of a map, wherein a length of an object, for example another vehicle or a truck, can be determined and this length is now further processed, wherein in particular the constraint of the Kalman filter is used for this purpose. The restricted Kalman filter can also be referred to as a constrained Kalman filter.

A minimum length, for example 2.5 m for passenger vehicles or 5 m for trucks, or a maximum length, for example 5 m for passenger vehicles, can thus be specified in dependence on the class determined by means of the camera, for example, wherein this specification is then specified in turn as a constraint to the Kalman filter for determining the length, so that this length is within these minimum and maximum values.

In particular, the classification of the object is thus carried out to estimate a length of the object The Kalman filter in particular filters over time, wherein a probability is specified, in particular by empirical experiments. In particular a minimum length and/or a maximum length for the object can be specified by the corresponding classification of the object in an object class. The Kalman filter then in turn operates under a condition or constraint, wherein this constraint for the Kalman filter is the determined class of the camera.

In particular, the filtering by means of the constrained Kalman filter can be carried out by means of the following formula under the condition D*x=d.

λ=(DPₙD^{T})⁻D( [symbol] −\tilde{x})=(DPₙD^{T})⁻¹(D [symbol] −d)

The constraint results as an estimation in this way:

Pₙ⁻(\tilde{x}− [symbol] )+D^{T}π=0⇔\tilde{x}− [symbol] +PₙD^{T}λ=0⇔\tilde{x}= [symbol] −PₙD^{T}λ= [symbol] −PₙD^{T}(DPₙD^{T})⁻¹(D [symbol] −d)

, wherein λ corresponds to the Lagrange multiplier and is typically used to find the solution of a least square problem with a secondary condition. \tilde{x} describes the new estimation in consideration of the constraint. [symbol] corresponds to the expectation of the estimation without consideration of the constraint, thus the result of the Kalman filter. Pₙ is the covariance matrix of the estimation without consideration of the constraint, thus the result of the Kalman filter. D is the matrix, which specifies the linear constraint on the state, for example if only a specific value of the state is to be bound to a fixed value, D=[0,0,0,1], if this is the fourth value of the state. D can also be used to specify a constraint on a linear combination of the state parameters, for example D=[1,0,0,0,0.5] will specify a restriction on the first component of the state plus half the last component. Multiple linear constraints can be specified simultaneously, D then has multiple lines, for example D=[0,0,0,1; 1,0,0,0,0] specifies two constraints, one on the first value, one on the last value of the state. d is the value of the desired constraint(s). The number of the lines of d is equal to that of D.

According to one advantageous embodiment, the object is classified in the camera by means of a Bayesian filter of the camera. In particular, a simple and nonetheless reliable method can be provided by means of the Bayesian filter, by means of which the classification of the camera can be carried out In particular, the Bayesian filter uses corresponding probabilities and can decide under given conditions whether a class change has taken place. In particular, the Bayesian filter is thus switched between the classification of the camera and the electronic computing device, so that a sporadic class change of the camera can be filtered out by means of the Bayesian filter. A brief class jump during the evaluation of the camera can thus be neglected, so that a more reliable classification can be carried out. The classification of the Bayesian filter is then in turn transferred to the electronic computing device for further evaluation.

It is furthermore advantageous if a passenger vehicle and a truck and a pedestrian and a bicycle and a motorcycle are specified for classification as object classes of the camera and/or electronic computing device. Different object classes can thus be specified, wherein the object can then be classified in one of these classes. In particular, possible road users are thus classifiable, by which robust object tracking is enabled.

It is furthermore advantageous if an equal probability in the Bayesian filter is assigned to each of the object classes of the camera at the beginning of a classification. If, for example, five classes should be specified, the probability in the Bayesian filter at the beginning of the object classification would thus be 0.2 in particular. Upon initialization of the object tracking, the same value is thus assigned to the respective probabilities for the object classes.

Furthermore, it has proven to be advantageous if the probabilities in the Bayesian filter result in a value of 1 when added up. Different object classes can thus be taken into consideration, wherein robust object tracking, which in particular counters the sporadic object class change by the camera, is carried out by means of the Bayesian filter.

In a further advantageous embodiment, an object class is determined by means of a further electronic computing device of the camera and this is transferred to the Bayesian filter and a respective probability of an object class in the Bayesian filter is increased after a respective object class determination by the further electronic computing device of the camera. In particular, an object class can thus be determined by the camera, which is then in turn transferred to the Bayesian filter. If the camera should then determine a passenger vehicle as the object class, for example, the Bayesian filter thus increases the probability for the object class passenger vehicles, while the other probabilities for the other classes decrease. For example, if the camera determines by means of the further electronic computing device that the object can be assigned to the object class of a passenger vehicle, the probability in the Bayesian filter is thus set to 0.7, for example. The further probabilities for the further object classes decrease accordingly. The classification of the camera can thus be filtered, by which more robust object tracking can be carried out.

Furthermore, it has proven to be advantageous if upon reaching a probability threshold value for one of the object classes by the Bayesian filter, the classification of the object is carried out by means of the camera and this is transferred to the electronic computing device. In particular, it can be provided, for example, if the probability in the Bayesian filter should be higher than 0.6, a corresponding classification is thus carried out by the Bayesian filter. If a change should then be carried out by the camera, wherein the camera then in turn transfers a different object class to the Bayesian filter, the Bayesian filter will thus reject this information, since the probability is still too high to carry out an object class change. In order that an object class change is carried out by the items of information of the camera, the camera is to communicate with the Bayesian filter over a specified time that a corresponding class change is to be carried out

It has furthermore proven to be advantageous if a classification of the object by means of the Bayesian filter is carried out at a value of 0.6 as the probability threshold value. Robust object tracking can thus be carried out, since a corresponding classification is first carried out upon exceeding 0.6 as the probability. Sporadic class changes by the camera can thus remain unconsidered.

It is also advantageous if the constraint of the Kalman filter is specified as a linear constraint. In particular, for example, it can be provided that the constrained Kalman filter, from an estimation of the Kalman filter after a measurement update (update) xₙ, carries out a further estimation x, so that the linear constraint is met

D*x=d

Reliable object tracking can thus be carried out

According to a further advantageous embodiment, if the second length of the object determined by means of the camera is greater than the specified first length, the current length is then adapted by means of the constrained Kalman filter to the second length determined by means of the camera. A reliable length update is thus enabled.

Furthermore, if the second length of the object determined by means of the camera is less than the specified first length, the current length is then adapted by means of the Kalman filter to the specified first length. A reliable and robust length update can thus be carried out.

It has furthermore proven to be advantageous if the object is detected in the surroundings by means of an ultrasonic sensor device and/or by means of a radar sensor device and/or by means of a lidar sensor device as a detection device. The object can preferably be detected by means of the radar sensor device and/or by means of the lidar sensor device, since these in particular have a long range and a high resolution. Furthermore, a length of the object can be determined reliably by means of the radar sensor device and/or by means of the lidar sensor device.

A further aspect of the invention relates to a computer program product having program code means that are stored in a computer-readable medium in order to carry out the method for operating the assistance system according to the preceding aspect when the computer program product is run on a processor of an electronic computing device.

Still a further aspect of the invention relates to a computer-readable storage medium having a computer program product according to the preceding aspect. The computer-readable storage medium can be formed in particular as part of an electronic computing device.

A further aspect of the invention relates to an assistance system for a motor vehicle having at least one detection device, having a camera, and having an electronic computing device, which has at least one constrained Kalman filter, wherein the assistance system is designed to carry out a method according to the preceding aspect. In particular, the method is carried out by means of the assistance system.

Still a further aspect of the invention relates to a motor vehicle having an assistance system according to the preceding aspect The motor vehicle is embodied in particular as a passenger vehicle. The motor vehicle can be operated in particular as an at least semiautonomous motor vehicle or as a fully autonomous motor vehicle.

Advantageous embodiments of the method are to be viewed as advantageous embodiments of the computer program product, the computer-readable storage medium, the assistance system, and the motor vehicle. The assistance system and the motor vehicle have concrete features for this purpose which enable the method or an advantageous embodiment thereof to be carried out

Further features of the invention result from the claims, the figures, and the description of the figures. The features and combinations of features that are cited in the description above and also the features and combinations of features that are cited in the description of the figures below and/or as shown in the figures alone can be used not only in the respectively indicated combination but also in other combinations without departing from the scope of the invention. The invention is therefore also intended to be considered to comprise and disclose embodiments that are not explicitly shown and explained in the figures but that result and can be generated from the explained embodiments, by way of separate combinations of features. Embodiments and combinations of features that therefore do not have all the features of an originally formulated independent claim should also be regarded as disclosed. Embodiments and combinations of features that go beyond or differ from the combinations of features set out in the back-references of the claims should furthermore be considered to be disclosed, in particular by the embodiments set out above.

The invention will now be explained in more detail using preferred exemplary embodiments and with reference to the accompanying drawings.

In the figures:

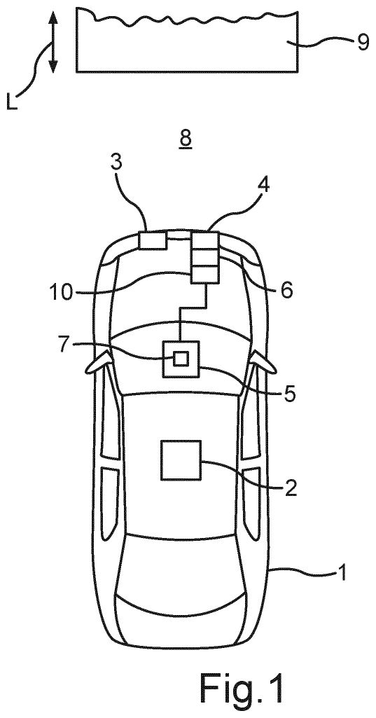

FIG. 1 shows a schematic top view of a motor vehicle having one embodiment of an assistance system; and

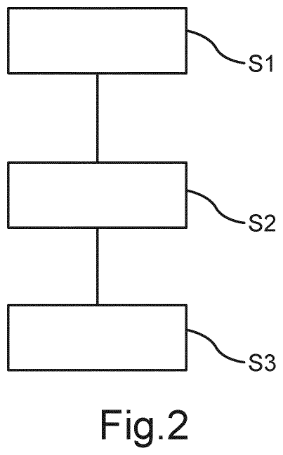

FIG. 2 shows a schematic flow chart according to one embodiment of the method.

In the figures, identical or functionally identical elements are provided with the same reference numerals.

FIG. 1 shows a schematic top view of a motor vehicle 1 having one embodiment of an assistance system 2. The assistance system 2 has at least one detection device 3 and a camera 4. Furthermore, the assistance system 2 has an electronic computing device 5. The camera 4 furthermore in particular has a further electronic computing device 6. The electronic computing device 5 furthermore in particular has a constrained Kalman filter 7. The detection device 3 can be designed in particular as an ultrasonic sensor device and/or as a radar sensor device and/or as a lidar sensor device.

Furthermore, FIG. 1 shows that an object 9 can be detected in surroundings 8 of the motor vehicle 1. The object 9 can be, for example, a passenger vehicle, a truck, a pedestrian, a bicycle, or a motorcycle. In the present case, the object 9 is shown in particular as a truck.

FIG. 2 shows a schematic view of a flow chart of the method. In the method for operating the assistance system 2 of the motor vehicle 1, the object 9 in the surroundings 8 of the motor vehicle 1 is detected by means of the detection device 3 of the assistance system 2 and the object 9 is classified by means of the electronic computing device 5 of the assistance system 2 for further evaluation by means of the electronic computing device 5, wherein a first length L of the object 9 is specified for the further evaluation by means of the electronic computing device 5 as a function of the classification, and wherein in addition the object 9 is detected and evaluated by means of the camera 4 of the assistance system 2 and is classified by means of the camera 4 and a second length L of the object 9 is determined and the classification and the second length L are transferred to the electronic computing device 5 for further evaluation.

It is provided that the specified first length L is adapted as a function of the second length L determined by means of the camera 4 to form a current length L by means of the electronic computing device 5 and the length L is updated by means of the constrained Kalman filter 7 of the electronic computing device 5, wherein the constraint of the Kalman filter 7 is specified by the classification determined by means of the camera 4.

In particular, it can be provided that the object 9 is classified in the camera 4 by means of a Bayesian filter 10 of the camera 4. A passenger vehicle and a truck and a pedestrian and a bicycle and a motorcycle can be specified for classification as object classes of the camera 4 and/or the electronic computing device 5, for example.

In particular, in a first step S1 of the method, an equal probability in the Bayesian filter 10 is assigned to each of the object classes of the camera 4 at the beginning of a classification. The probabilities in the Bayesian filter 10 result in particular in the value of 1 when added up.

In a second step S2 of the method, it is provided in particular that an object class is determined by means of the further electronic computing device 6 of the camera 4 and this is transferred to the Bayesian filter 10 and a respective probability of an object class in the Bayesian filter 10 is increased after a respective object class determination by the further electronic computing device 6 of the camera 4. In other words, it can be provided in particular that when the classification has been carried out by the camera 4, this is transferred to the Bayesian filter 10, wherein the probabilities are defined, for example, in such a way that a probability indicates that the camera 4 specifies, for example, that the object 9 is a motor vehicle, wherein the object 9 is also a motor vehicle. A true positive rate for the motor vehicle or the passenger vehicle can thus be specified. Furthermore, the Bayesian filter also requires the probabilities for the case that the camera 4 reflects that it is not a passenger vehicle, although it is a passenger vehicle. In sum, all probabilities are 1. In particular, the classification of the object 9 is carried out by means of the camera 4 and this is transferred to the electronic computing device 5 first when a probability threshold value for one of the object classes is reached by the Bayesian filter 10, wherein the probability threshold value can be 0.6, for example.

In a third step S3, the length L is then determined by means of the constrained Kalman filter 7, wherein the constraint is in particular a linear constraint For example, a class having the highest probability can be selected by the Bayesian filter 10. In dependence on this class, for example, a minimum length, for example 2.5 m for passenger vehicles or 5 m for trucks, or a maximum length, for example 5 m for passenger vehicles, can be specified, wherein this specification is then specified in turn as a constraint to the Kalman filter 7 for determining the length L, so that the determined length L is in these minimum and maximum value ranges. Furthermore, in the third step S3, it can be provided in particular that when the length L of the object 9 determined by means of the camera 4 is greater than the specified first length L, the current length L is then adapted by means of the constrained Kalman filter 7 to the second length L determined by means of the camera 4. Alternatively, if the length L of the object 9 determined by means of the camera 4 is less than the specified first length L, the current length L is then adapted by means of the constrained Kalman filter 7 to the specified first length L.

In particular, the constraint of the Kalman filtering can be carried out, for example, using a Kalman filter estimation after the first detection update xₙ and a further estimation x, wherein this then meets the linear constraint

D*x=d

In particular, the filtering by means of the constrained Kalman filter can be carried out by means of the following formula under the condition D*x=d.

λ=(DPₙD^{T})⁻¹D( [symbol] −\tilde{x})=(DPₙD^{T})⁻¹(D [symbol] −d)

The constraint results as an estimation in this way:

Pₙ⁻¹(\tilde{x}− [symbol] )+D^{T}λ=0⇔\tilde{x}− [symbol] +PₙD^{T}λ=0⇔\tilde{x}= [symbol] −PₙD^{T}λ= [symbol] −PₙD^{T}(DPₙD^{T})⁻¹(D [symbol] −d)

, wherein λ corresponds to the Lagrange multiplier and is typically used to find the solution of a least square problem with a secondary condition. \tilde{x} describes the new estimation in consideration of the constraint. [symbol] corresponds to the expectation of the estimation without consideration of the constraint, thus the result of the Kalman filter. Pₙ is the covariance matrix of the estimation without consideration of the constraint, thus the result of the Kalman filter. D is the matrix, which specifies the linear constraint on the state, for example if only a specific value of the state is to be bound to a fixed value, D=[0,0,0,1], if this is the fourth value of the state. D can also be used to specify a constraint on a linear combination of the state parameters, for example D=[1,0,0,0,0.5] will specify a restriction on the first component of the state plus half the last component. Multiple linear constraints can be specified simultaneously, D then has multiple lines, for example D=[0,0,0,1; 1,0,0,0,0] specifies two constraints, one on the first value, one on the last value of the state. d is the value of the desired constraint(s). The number of the lines of d is equal to that of D.

Overall, the figure shows a determination of the length by means of a camera 4 based on a filtered class.

1. A method for operating an assistance system of a motor vehicle, the method comprising:
detecting an object in the surroundings of the motor vehicle by a detection device of the assistance system;
classifying the object by an electronic computing device of the assistance system for further evaluation by the electronic computing device,
wherein a first length of the object is specified for the further evaluation by the electronic computing device as a function of the classification, and
wherein the object is detected and evaluated by a camera of the assistance system and is classified by the camera;
determining a second length of the object,
wherein the classification and the second length are transferred to the electronic computing device for further evaluation,
wherein the specified first length is adapted as a function of the second length determined by the camera to form a current length by the electronic computing device; and
updating the current length by a constrained Kalman filter of the electronic computing device, wherein the constraint of the Kalman filter is specified by the classification determined by the camera.

2. The method as claimed in claim 1, wherein the object is classified in the camera by a Bayesian filter of the camera.

3. The method as claimed in claim 1, wherein a passenger vehicle and a truck and a pedestrian and a bicycle and a motorcycle are specified for classification as object classes of the camera and/or the electronic computing device.

4. The method as claimed in claim 2, wherein each of the object classes of the camera is assigned an equal probability in the Bayesian filter at the beginning of a classification.

5. The method as claimed in claim 4, wherein the probabilities in the Bayesian filter result in a value of 1 when added up.

6. The method as claimed in claim 4, wherein an object class is determined by means of a further electronic computing device of the camera and this is transferred to the Bayesian filter and a respective probability of an object class in the Bayesian filter is increased after a respective object class determination by the further electronic computing device of the camera.

7. The method as claimed in claim 6, wherein if a probability threshold value for one of the object classes is reached by the Bayesian filter, the classification of the object is carried out by the camera and this is transferred to the electronic computing device.

8. The method as claimed in claim 7, wherein at a value of 0.6 as the probability threshold value, a classification of the object is carried out by the Bayesian filter.

9. The method as claimed in claim 1, wherein the constraint of the Kalman filter is specified as a linear constraint.

10. The method as claimed in claim 1, wherein if the second length of the object determined of the camera is greater than the specified first length, the current length is adapted by the constrained Kalman filter to the second length determined by the camera.

11. The method as claimed in claim 1, wherein if the second length of the object determined by the camera is less than the specified first length, the current length is adapted by the constrained Kalman filter to the specified first length.

12. The method as claimed in claim 1, wherein the object is detected in the surroundings by an ultrasonic sensor device and/or by means of a radar sensor device and/or by means of a lidar sensor device as the detection device.

13. A computer program product having program code stored in a computer-readable medium in order to carry out the method as claimed in claim 1 when the computer program product is run on a processor of an electronic computing device.

14. A computer-readable storage medium having a computer program product as claimed in claim 13.

15. An assistance system for a motor vehicle comprising:
at least one detection device;
a camera; and
an electronic computing device, which has at least one constrained Kalman filter,
wherein the assistance system is configured to carry out a method as claimed in claim 1.
